(19) United States
(12) Patent Application Publication
(10) Pub. No.: US 2020/0311817 A1
(43) Pub. Date: Oct. 1, 2020

(54) SYSTEM AND METHOD FOR INTERCONNECTED AND NETWORKED ASSESSMENT PLATFORM

(71) Applicant: NATIONALRESP, LLC, Dallas, TX (US)

(72) Inventors: S. Lewis Hill, Dallas, TX (US); Francis C. Muller, Collegeville, PA (US); Ryan Hennessy, Philadelphia, PA (US)

(21) Appl. No.: 16/835,691

(22) Filed: Mar. 31, 2020

Related U.S. Application Data
(60) Provisional application No. 62/827,534, filed on Apr. 1, 2019.
(60) Provisional application No. 62/898,819, filed on Sep. 11, 2019.

(51) Int. Cl. G06Q 40/06; G06Q 50/16; G06Q 30/02

(52) U.S. Cl. CPC G06Q 40/06; G06Q 30/0201; G06Q 50/167; G06Q 50/163

(57) ABSTRACT

An electronic device for an interconnected and networked assessment platform includes a memory and at least one processor coupled to the memory. The at least one processor is configured to receive a request for a assessment operation, wherein the request includes a property identification for a property, calculate a full market value of the property, obtain assessment ratio study information for a property area, wherein the property area is a geographical area related to the property, determine an assessment ratio for the property area based on the obtained assessment ratio study information, apply the assessment ratio to the full market value of the property, and transmit a reconciled full market value in response to the request.

### CROSS-REFERENCE TO RELATED APPLICATIONS

This application claims the benefit of U.S. Provisional Application No. 62/827,534, filed Apr. 1, 2019, entitled SYSTEM AND METHOD FOR VALUE ASSESSMENT ANALYSIS. This application also claims the benefit of U.S. Provisional Application No. 62/898,819, filed Sep. 11, 2019, entitled SYSTEM AND METHOD FOR INTERCONNECTED VALUATION ASSESSMENT PLATFORM. The contents of U.S. Provisional Application Nos. 62/827,534 and 62/898,819 are incorporated by reference herein in their entirety.

### TECHNICAL FIELD

This disclosure generally relates to value assessment systems and software. More specifically, this disclosure relates to a system and method for an interconnected and networked assessment platform.

### BACKGROUND

Property appraisal or assessment processes tend to include a certain amount of subjectivity in determining property values, allowing appraisers or assessors to consider only a few objective factors and then to subjectively valuate a property. In rural areas, reliance on comparable property sales (“comps”) can present issues in valuation because of the larger distance between properties. While automated valuation model (AVM) or broker price opinion (BPO) methods can provide fast valuations, the reliability of these methods is questionable.

### SUMMARY

This disclosure relates to a system and method for an interconnected and networked assessment platform.

In one aspect thereof, an electronic device for value assessment analysis includes a memory and at least one processor coupled to the memory. The at least one processor is configured to receive a request for a assessment operation, wherein the request includes a property identification for a property, calculate a full market value of the property, obtain assessment ratio study information for a property area, wherein the property area is a geographical area related to the property, determine an assessment ratio for the property area based on the obtained assessment ratio study information, apply the assessment ratio to the full market value of the property, and transmit a reconciled full market value in response to the request.

In one or more embodiments, the assessment ratio is a median assessment ratio for the property area.

In one or more embodiments, the at least one processor is further configured to determine that property data associated with the property is stored in a database connected to the electronic device, and determine that the property data is outdated.

In one or more embodiments, the at least one processor is further configured to generate an application programming interface (API) call including the property identification, transmit the API call to a location services system, and receive location data associated with the property from the location services system.

In one or more embodiments, the at least one processor is further configured to retrieve updated property data associated with the property from a tax assessment system or from an appraisal system, and store the updated property data in the database in association with the property.

In one or more embodiments, to calculate the full market value, the at least one processor is further configured to calculate the full market value based on the updated property data.

In one or more embodiments, the updated property data includes tax assessment data for the property.

In one or more embodiments, the at least one processor is further configured to retrieve information on at least one comparable property from the tax assessment system or from the appraisal system, and calculate the full market value for the property based on the information on the at least one comparable property.

In one or more embodiments, the at least one processor is further configured to create an identification for the at least one comparable property by incrementing or decrementing a value of the property identification for the property, generate another API call including the identification for the at least one comparable property, transmit the other API call to the location services system, receive location data associated with the at least one comparable property from the location services system, and retrieve the information on the at least one comparable property from tax assessment system or from the appraisal system using the location data associated with the at least one comparable property.

In one or more embodiments, to calculate the full market value for the property based on the information on the at least one comparable property, the at least one processor is further configured to discard any comparable property outliers of the at least one comparable property based on at least sales price, and calculate a mean value of the at least one comparable.

In another aspect thereof, a method of an electronic device comprises receiving a request for a assessment operation, wherein the request includes a property identification for a property, calculating a full market value of the property, obtaining assessment ratio study information for a property area, wherein the property area is a geographical area related to the property, determining an assessment ratio for the property area based on the obtained assessment ratio study information, applying the assessment ratio to the full market value of the property, and transmitting a reconciled full market value in response to the request.

In one or more embodiments, the assessment ratio is a median assessment ratio for the property area.

In one or more embodiments, the method further comprises determining that property data associated with the property is stored in a database connected to the electronic device, and determining that the property data is outdated.

In one or more embodiments, the method further comprises generating an application programming interface (API) call including the property identification, transmitting the API call to a location services system, and receiving location data associated with the property from the location services system.

In one or more embodiments, the method further comprises retrieving updated property data associated with the property from a tax assessment system or from an appraisal system, and storing the updated property data in the database in association with the property.

In one or more embodiments, calculating the full market value includes calculating the full market value based on the updated property data.

In one or more embodiments, the updated property data includes tax assessment data for the property.

In one or more embodiments, the method further comprises retrieving information on at least one comparable property from the tax assessment system or from the appraisal system, and calculating the full market value for the property based on the information on the at least one comparable property.

In one or more embodiments, the method further creating an identification for the at least one comparable property by incrementing or decrementing a value of the property identification for the property, generating another API call including the identification for the at least one comparable property, transmitting the other API call to the location services system, receiving location data associated with the at least one comparable property from the location services system, and retrieving the information on the at least one comparable property from tax assessment system or from the appraisal system using the location data associated with the at least one comparable property.

In one or more embodiments, calculating the full market value for the property based on the information on the at least one comparable property includes discarding any comparable property outliers of the at least one comparable property based on at least sales price, and calculating a mean value of the at least one comparable.

Other technical features may be readily apparent to one skilled in the art from the following figures, descriptions, and claims.

### BRIEF DESCRIPTION OF THE DRAWINGS

For a more complete understanding, reference is now made to the following description taken in conjunction with the accompanying Drawings in which:

FIG. 1 illustrates an example network configuration according to this disclosure;

FIG. 2 illustrates a flowchart of a value assessment analysis process in accordance with this disclosure;

FIG. 3 illustrates an example interconnected valuation assessment platform in accordance with this disclosure;

FIG. 4 illustrates a flowchart of a valuation platform analysis process in accordance with this disclosure;

FIG. 5 illustrates an example interconnected valuation assessment platform in accordance with this disclosure;

FIGS. 6A and 6B illustrate a flowchart of a valuation platform analysis process in accordance with this disclosure;

FIGS. 7A-7C illustrate various views of an example market-based valuation service GUI in accordance with this disclosure;

FIG. 8 illustrates a sequence diagram of an example market-based analysis process in accordance with this disclosure; and

FIG. 9 illustrates a flowchart of an analysis process in accordance with this disclosure.

### DETAILED DESCRIPTION

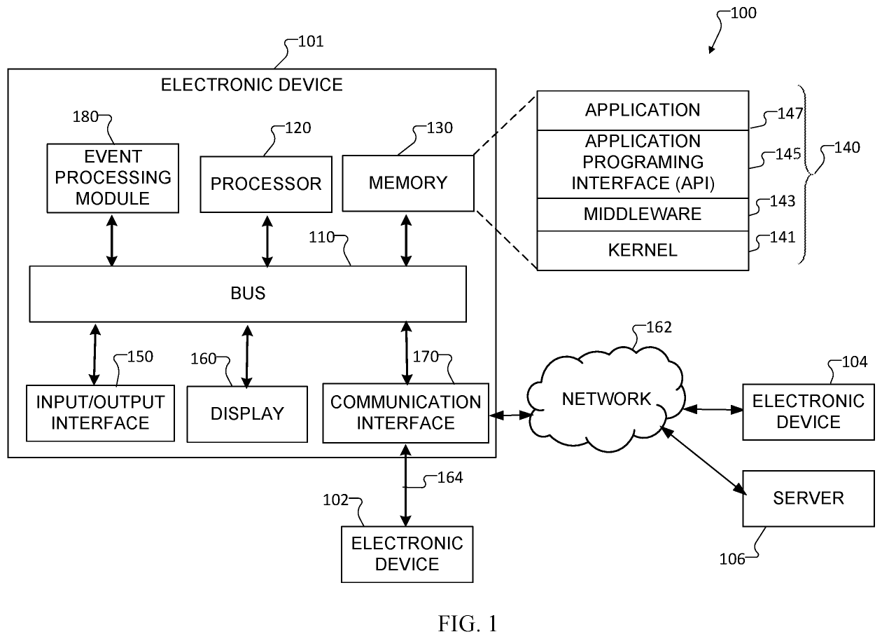

FIGS. 1-9, discussed below, and the various embodiments used to describe the principles of the present disclosure in this patent document are by way of illustration only and should not be construed in any way to limit the scope of the disclosure. Those skilled in the art will understand that the principles of the disclosure may be implemented in any type of suitably arranged device or system.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic appcessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such SAMSUNG HOMESYNC, APPLETV, or GOOGLE TV), a gaming console (such as an XBOX, PLAYSTATION, or NINTENDO), an electronic dictionary, an electronic key, a camcorder, or an electronic picture frame.

Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MM) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

An assessor's appraisers appraise a large universe of properties by developing appraisal models, as well as undertaking mass appraisal techniques. Mass appraisal is a systematic appraisal of a group of properties as of a given date using a set of standardized procedures and statistical testing. Accessors are often required to appraise all property at market value as of January 1 of every tax year. Market value can be defined as the price at which a property would transfer for cash or its equivalent under prevailing market conditions if exposed for sale in an open marketplace with a reasonable time for a seller to find a purchaser, both the seller and purchaser know of all uses and purposes to which the property is adapted and for which it is capable of being used and the enforceable restrictions on its use, and both the seller and purchaser seek to maximize their gains and neither is in a position to take advantage of the exigencies of the other.

Assessments performed by an assessor's district typically fall into one of three categories: building permits, miscellaneous inspections, and reappraisal. Three tasks are performed during a field cycle, which can, for example, be a period between August 1 and April 1. The field cycle can include permit work, miscellaneous inspections, and reappraisals. Reappraisals can be performed at various intervals depending local rules for the geographical location of the of the property, such as intervals of every 1-3 years. A building permit is a document issued by a city which gives a property owner permission to build on or modify a piece of real property. After a property owner makes an application for a building permit, and has been approved, a copy is forwarded to the corresponding assessor's district. Assessor's districts use these copies as a tool to discover new construction and/or alterations to existing structures. The two main types of building permits are new construction permits for newly constructed properties and miscellaneous permits for items such as additions, garages, pools, etc. New construction permits often include measuring and sketching the exterior perimeter of the property, and recording other physical characteristics such as building class, living area square footage, condition, bathroom count, or other characteristics. Miscellaneous permits often include exterior measurements when required, and adjustments to the improvement's physical characteristics are updated to the account.

If, during the initial inspection the appraiser finds the permit work to still be in process, then the appraiser will recheck again close to the assessment deadline date. If the property is still under construction towards the end of the year, or the work has not begun, the appraiser may be required to determine the level of completion and flag the account for re-inspection the following appraisal year. According to most property tax codes, the assessor's district appraises the property in its current state as of January 1 of any given tax year. Therefore, a 50% complete home gets appraised at 50%, a 75% complete swimming pool gets appraised at 75%, etc. An important aspect of appraising property is to have accurate property descriptions. This is achieved through actual field inspections performed by the assessor's appraisers. Mass appraisal includes the systematic appraisal of groups of properties as of a given date using standardized procedures and statistical testing. Property tax codes require assessors' districts to maintain property records and assign a January 1 value to all property. Mass appraisal provides appraisal districts the ability to accomplish such a large task in a proficient and accurate manner. The annual reappraisal effort is where the mass appraisal process occurs.

Each residential account is assigned to a specific neighborhood. A residential neighborhood is a defined market area. Neighborhoods vary in size but typically do not cross over into different independent school districts. Residential models are developed at the neighborhood building class level, which ensures more accurate and equitable market values. In some geographical areas, there can be up to twenty-eight or more residential building classifications, which as be retrieved using the system and method described herein from networked devices. Specific mass appraisal models can be developed by neighborhood and further by building class. The same model can then be applied to all the same classed properties within a specific neighborhood, which ensures more accurate and equitable market values.

Residential neighborhoods can be targeted for reappraisal based on a neighborhood sales ratio analysis. A sales ratio analysis compares the neighborhood sale prices to current appraised values, with the goal being to appraise all properties at 100% of market value. Reappraisal often occurs if a neighborhood sales ratio is less than 95% or greater than 105% of market value. Residential neighborhood sales ratio analysis can occur at certain points during the year, such as January and March of every year for all residential neighborhoods. Such an analysis can use the residential neighborhood and building classifications by determining the level of assessment at the neighborhood and building class level, applying a neighborhood building class location factor to the neighborhood class model for both the sold and unsold properties to predict what homes will sell for based on what has sold, and undertaking a neighborhood value review of the newly adjusted proposed market values.

For residential appraisals, sold properties used in model development are inspected and reviewed prior to neighborhood reappraisal. Physical characteristics are reviewed for accuracy, and an appraiser undertakes a neighborhood value review to review all new proposed market values. A neighborhood drive-out often also occurs. Digital photographs, aerial photography, and geographical information system (GIS) maps are also typically reviewed. Residential approaches to determining value can include a Mass Appraisal Records System (MARS). Three approaches to valuation include a cost approach, a sales approach, and an income approach. A cost approach can include calculating a replacement cost new (RCN) of a house, deducting an appropriate amount of depreciation, and adding the land value to the replacement cost new less depreciation (RCNLD) to arrive at an estimated market value. Depreciation can be determined by the effective age and a condition/desirability/utility (CDU) rating. A primary value approach as part of the cost approach can also be used during the reappraisal effort by modifying the cost approach based on recent sales information by building class by neighborhood. Equity can be achieved by using the same location factor for all similarly classed properties within a neighborhood. The cost approach is useful for unique properties or if there is a lack of sale comparables.

A residential sales approach can include comparing property being appraised to similar properties that have recently sold and making adjustments to sale comparables when compared to the subject property. For example, if sold property had a pool but subject property does not, then an adjustment would be warranted. The sales approach can be used to value land only accounts. The sales approach can also be used during meetings with the taxpayer or an authorized agent and/or at a formal appraisal review board hearing.

Commercial buildings can be classified as well. For example, commercial building classifications can include office building, multi-family property (apartments), retail property (shopping centers), industrial property (warehouses), all commercial buildings, properties on commercial zoned land, commercial zoned land tracts, or other commercial building classifications. In some areas, there can be up to 81 or more commercial building classifications. Commercial building permits can include new construction permits and miscellaneous permits for remodels, additions, repairs, and demolitions. In some areas, inspections are completed prior to January 15, partially complete properties are valued as of January 1, and partially compete properties are re-inspected annually until completed. Commercial reappraisal in some areas can be undertaken January 15 to April 1 on land market areas (LMA) or improved market areas (IMA). LMA and IMA are targeted for reappraisal to ensure accurate and equitable values. IMA can include office buildings, multi-family properties, retail properties, and industrial properties. Income models are developed annually for IMA areas. Class A, B, and C models can be developed. Market data can be analyzed, such as income and expense statements, rent rolls, data received during appraisal review board (ARB) process, and local and national publications.

Commercial properties can also be valuated using cost, sales, and income approaches. A commercial cost approach can calculate cost new (RCN) less depreciation (LD). This approach can also use age-life tables, national cost publication services, and market data. Cost tables generate price per square foot. Land value can also be added to improvement value (RCNLD). The commercial cost approach is useful for special use properties, new construction, or when there is limited sales data or limited income data. A commercial sales approach analyzes sales of comparable properties compared to the subject property. Sales data can include sale surveys, market research company data, third-party appraisals, local media, and appraisal review board processes. MARS allows an appraiser to select sale comparable properties. Comparables can also be adjusted for sale conditions, land size, improvement size, age, condition, and location. A commercial income approach can use capitalization of income or direct capitalization. A single year's net operating amount can be divided by a market cap rate. Market income data can also be compared to subject property income data.

The appraisal district can also collect and enter income data into a database, which can be accessed by the applications and systems disclosed herein. This income data can include income and expense data, rental data, occupancy data, secondary income data, and/or net operating income data. Capitalization rates can be estimated based on sale pries and net operating incomes. Capitalization rates can also be determined from outside sources such as from market research companies or real estate publications. Capitalization rates can be used for IMA income models. Subject property income components can also be compared to market indicators. The income approach can be useful for incoming producing properties such as offices, apartments, retail properties, and industrial properties.

FIG. 1 illustrates an example network configuration 100 in accordance with various embodiments of this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network environment 100. The electronic device 101 can include at least one of a bus 110, a processor 120, a memory 130, an input/output (TO) interface 150, a display 160, a communication interface 170, or an event processing module 180. In some embodiments, the electronic device 101 may exclude at least one of the components or may add another component.

The bus 110 includes a circuit for connecting the components 120 to 180 with one another and transferring communications (such as control messages and/or data) between the components. The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor can be a graphics processor unit (GPU). For example, the processor can retrieve tax assessment and sales comparables for a given property, determine the full market value for the property, obtain ratio study information for a property area, calculate a median appraisal ratio for the property area, apply the median ratio to the full market value of the property, and output a reconciled value.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or a memory 130) used to perform operations or functions implemented in other programs (such as the middleware 143, API 145, or application program 147). The kernel 141 provides an interface that allows the middleware 143, the API 145, or the application 147 to access the individual components of the electronic device 101 to control or manage the system resources.

The middleware 143 can function as a relay to allow the API 145 or the application 147 to communicate data with the kernel 141, for example. A plurality of applications 147 can be provided. The middleware 143 is able to control work requests received from the applications 147, for example, by allocating the priority of using the system resources of the electronic device 101 (such as the bus 110, the processor 120, or the memory 130) to at least one of the plurality of applications 147.

The API 145 is an interface allowing the application 147 to control functions provided from the kernel 141 or the middleware 143. For example, the API 145 includes at least one interface or function (such as a command) for filing control, window control, image processing or text control.

The IO interface 150 serves as an interface that can, for example, transfer commands or data input from a user or other external devices to other component(s) of the electronic device 101. Further, the TO interface 150 can output commands or data received from other component(s) of the electronic device 101 to the user or the other external device.

The display 160 may include, for example, a liquid crystal display (LCD), a light emitting diode (LED) display, an organic light emitting diode (OLED) display, a quantum light emitting diode (QLED) display, a microelectromechanical systems (MEMS) display, or an electronic paper display. The display 160 can also be a depth-aware display, such as a multi-focal display. The display 160 may display various contents (such as text, images, videos, icons, or symbols) to the user. The display 160 may include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with the network 162 or 164 through wireless or wired communication to communicate with the external electronic device. The communication interface 170 can be a wired or wireless transceiver or any other component for transmitting and receiving signals.

The electronic device 101 further includes one or more sensors that can meter a physical quantity or detect an activation state of the electronic device 101 and convert metered or detected information into an electrical signal. For example, a sensor can include one or more buttons for touch input, one or more cameras, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an IR sensor, an ultrasound sensor, an iris sensor, a fingerprint sensor, etc. The sensor(s) can further include a control circuit for controlling at least one of the sensors included therein. Any of these sensor(s) can be located within the electronic device 101.

The wireless communication is able to use at least one of, for example, long term evolution (LTE), long term evolution-advanced (LTE-A), 5th generation wireless system (5G), mm-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include at least one of universal serial bus (USB), high definition multimedia interface (HDMI), recommended standard 232 (RS-232), or plain old telephone service (POTS). The network 162 may include at least one communication network, such as a computer network (like a local area network (LAN) or wide area network (WAN)), the Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function, according to embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. The server 106 can also include an event processing module (not shown) that may support the event processing module 180 implemented in the electronic device 101. For example, the event processing module 180 can process at least a part of information obtained from other elements (such as the processor 120, the memory 130, the input/output interface 150, or the communication interface 170) and can provide the same to the user in various manners.

While in FIG. 1 the event processing module 180 is shown to be a module separate from the processor 120, at least a portion of the event processing module 180 can be included or implemented in the processor 120 or at least one other module, or the overall function of the event processing module 180 can be included or implemented in the processor 120 or another processor. The event processing module 180 can perform operations according to embodiments of this disclosure in interoperation with at least one program 140 stored in the memory 130.

Although FIG. 1 illustrates one example of a network configuration 100, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

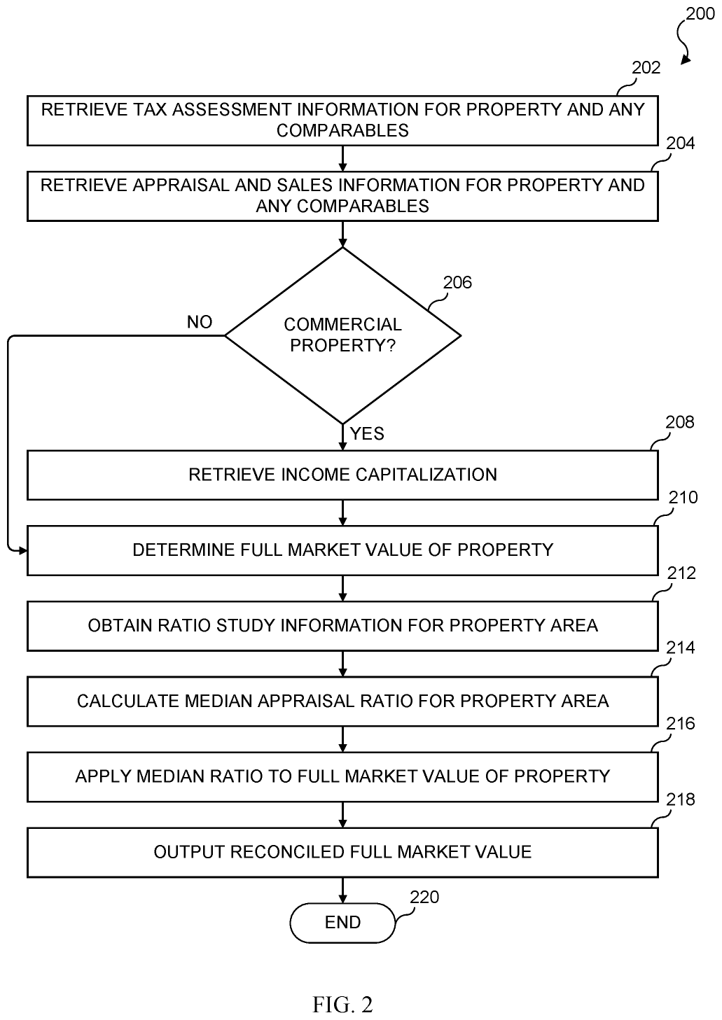

FIG. 2 illustrates a flowchart of a value assessment analysis process 200 in accordance with this disclosure. FIG. 2 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. For ease of explanation, the process 200 is described with respect to the processor 120 of any, or a combination, of the electronic devices 101, 102, or 104, or the server 106. However, the process 200 can be used with any other suitable device(s) and in any suitable system.

The process 200 begins at block 202. At block 202, the processor retrieves tax assessment information for a property and any information on comparables. At block 204, the processor retrieves appraisal and/or sales data for the subject property and any information for comparables. At decision block 206, the processor determines if the property is classified as a commercial property. If so, at block 208 the processor can retrieve income capitalization data. In some embodiments a cash-on-cash reconciliation can be performed by the processor using the capitalization data. If at decision block 206 the processor determines that the property is not a commercial property, the process 200 moves to block 210.

At block 210, the processor determines from the retrieved tax assessment comparables, the retrieved comparable sales, and/or the income capitalization data, a full market value for the property. In some embodiments, the full market value can be determined using additional information such as property inspection data. At block 212, the processor obtains ratio study information for an area in which the property is located. Ratio studies are studies performed by appraisal districts, state comptrollers, or other local or state governments to evaluate appraisals and/or tax assessments for given areas, counties, properties in particular school districts, etc. In some embodiments, the processor can access websites with ratio study information and pull this information from the website to be used in the process 200. For example, a property valued by an appraisal district or tax assessment office for $100,000 that sold for $105,000 has a ratio of 95%, or a 5% difference between the appraised or assessed value versus the sale price.

At block 214, the processor uses the obtained ratio studies to calculate a median ratio to full market value or to the assessed value. For example, if the ratio study data includes multiple properties in a same neighborhood as the subject property of the process 200, a median ratio for those properties is calculated. In some embodiments, the processor calculates a mean ratio. At block 216, the processor applies the median ratio to the full market value or assessed value of the property determined in block 210. For example, if the full market value is $500,000, and the median ratio difference is 8% (a 92% appraisal-to-sale-price ratio), the reconciled full market value can be calculated as $460,000. In some embodiments, depending on the data available to the processor, the ratio can be used to provide a higher reconciled value than the full market value, such as a value of $540,000. The process ends at block 220.

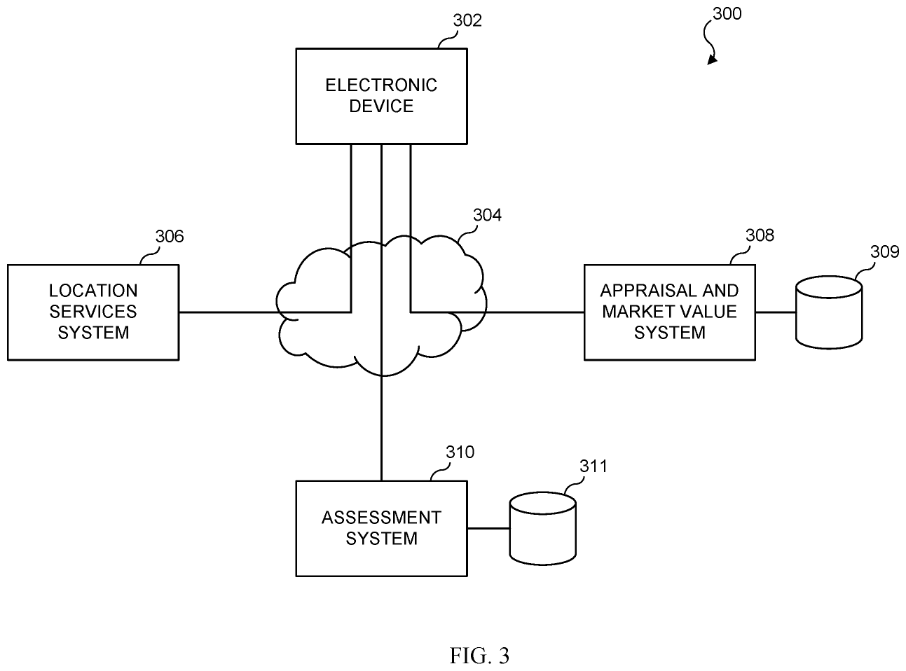

FIG. 3 illustrates an example interconnected valuation assessment platform 300 in accordance with this disclosure. It will be understood that the platform 300 can include the components illustrated in FIG. 1. The embodiment of the platform 300 shown in FIG. 3 is for illustration only. Other embodiments of the platform 300 could be used without departing from the scope of this disclosure.

The platform 300 includes an electronic device 302. The electronic device 302 can be a client device running valuation software. In some embodiments, the electronic device 302 can be the electronic device 101, and the valuation software can be the program 140. In various embodiments of the present application, the electronic device 302 can be interconnected with other entities in the platform 300. The other entities can be any number of outside sources for retrieving information to be used in an analysis performed by the software on the electronic device 302. For example, as shown in FIG. 3, the electronic device 302 can be connected over a network 304 to a location services system 306, an appraisal and market value system 308, and an assessment system 310. The network 304 can be the network 162 in some embodiments.

The systems and methods disclosed herein can use various valuation approaches. These approaches include Market Value Index (MVI) and Market Assessed Valuation (MAV) or Market Value Analysis (MVA) approaches. MAV or MVA is an approach that determines at least an initial valuation from tax assessments provided for a residential or commercial property, and includes comparable sales or comparable assessments of nearby and/or similar properties to further adjust the assessed price of the subject property. MVI is an approach that uses tax assessments divorced from comparable sales or assessments. As further described herein, each approach can further adjust the value of the property by an assessment ratio based on ratio studies performed for the geographic area, i.e., the county, in which the property is located. These inputs are used to provide a reconciled conclusion or valuation of the subject property that is adjusted by comparable sales and/or the assessment ratio to provide a more accurate market valuation than other approaches that rely solely on traditional assessment, valuation, or appraisal processes. Under each approach, other data and information can be provided, such as photos of the subject property, inspection information for the subject property, physical characteristics of the subject property, assessment data, comparable market data, or other data and information.

To gather information needed to perform a valuation such as MVA or MVI, the electronic device 302 can connect to the systems 306, 308, and 310 and retrieve public data therefrom without using manual inputs from a user of the electronic device 302. In some embodiments, information that is not directly retrievable from the systems 306, 308, and 310 can be gathered over time and stored in a location accessible by the electronic device 302, such as a local storage location at the electronic device 302, or on a data server accessible by the electronic device 302. The electronic device 302 communicates with the location services system 306 to retrieve location data for the subject property, and other properties near the subject property for use in retrieving comparable sales and assessments for the other properties. For example, the location services system 306 can be a system that uses GPS compatible devices and/or software to determine the location of devices and other objects, such as GOOGLE MAPS. The electronic device 302 can retrieve information from the location services system 306 by using an API associated with the location services system 306 to provide location data to the API and request data from the API. For example, when the electronic device 302 retrieves property comparables data, the electronic device 302 submits an API call to the location services system 306 providing the location of the subject property, such as an address, and retrieves information from the location services system 306 for properties near the subject property, such as neighboring properties, or a closest property if the subject property is in a rural area, or is otherwise separated from other properties. In some embodiments, properties to be used for comparables can be retrieved manually for the subject property.

To retrieve information on the subject property, the electronic device 302 can connect to the appraisal and market value system 308 to retrieve any stored data on appraisals or other valuations of the market value of the subject property. This data may be stored in a database or other data store 309 associated with the appraisal and market value system 308. For example, a Central Appraisal District for the county in which the subject property is located can store publicly accessible data for properties in the county, such as on a publicly accessible website, and this data can be accessed by inputting information identifying the property, such as an owner name or an address. The data stored in relation to a property on the appraisal and market value system 308 can include owner information, deed transfer date information, whether the property is residential or commercial, appraisal or full market value (FMV) information such as land valuation, improvements valuation, a total market value based on the sum of the land and improvements valuations, the year in which the appraisal or valuation was performed, and/or the year in which the next appraisal or valuation is scheduled to be performed, and location information such as an address, a subdivision or neighborhood, block and lot numbers, or other location information.

The data can also include information used in the appraisal of the FMV of the property, including an overall desirability rating, building class, construction type, i.e., frame, the year the property was built, the effective year built, the actual age of the property, total lot size, living area size (square footage), percent of building complete (can be less than 100% if construction is still being performed), number of stories, a depreciation percentage, foundation type (slab, pier and beam, etc.), roof type, i.e., gable, roof material, i.e., composite shingles, fence type, i.e., wood, metal, etc., exterior wall material, i.e., brick, stone, siding, etc., whether the property has a basement, heating and air condition types, i.e., central air, window units, etc., number of kitchens, bathrooms, and bedrooms, number of wet bars, number of fireplaces, and whether the property includes other amenities such as a sprinkler system, a deck, a spa, a pool, a sauna, or other amenities. The data can further include information on additional improvements, such as an attached garage, data on the type of property in the residential or commercial categories, such as a single family residence, data on taxing jurisdiction that identifies the city, school district, county, colleges, hospitals, and other entities that benefit from taxation of the property, data on any tax exemptions for the property, such as a homestead exemption, agricultural exemption, or other exemptions, the taxable value of the property for each benefiting entity minus the exemptions, tax rates for each of the benefiting entities, and total annual taxes to be levied on the property.

To further retrieve information on the subject property, the electronic device 302 can connect to the assessment system 310 to retrieve stored data on tax assessments for the subject property. This data may be stored in a database or other data store 311 associated with the assessment system 310. For example, the county in which the subject property is located can store publicly accessible data for properties in the county, such as on a publicly accessible county tax office or tax assessor website, and this data can be accessed by inputting information identifying the property, such as an owner name or an address. The data stored in relation to a property on the assessment system 310 can include any of the information listed above as being stored in the appraisal and market value system 308, and also the current tax levy on a property. Generally, the assessment system 310 will store the actual current tax levy for the property, whereas the appraisal and market value system often includes tax estimates based on the appraised value of the property. In some embodiments, the appraisal and market value system 308 and the assessment system 310 can include a value for the property that is the same, such as if the assessment system 310 uses a recent appraisal or sale price based on an appraisal or other similar valuation of the property as the tax assessment value. In some embodiments, the appraisal and market value system 308 and the assessment system 310 can provide different values, such as if the appraised value, or the full market value, is analyzed independently of the tax assessment value, and the assessment value can be the calculation of the actual value of the property rather than a market value.

The electronic device 302 can access the publicly available information of the appraisal and market value system 308 and the assessment system 310 to retrieve information on the subject property and any comparable properties based on location data for the property retrieved from the location services system 306. The electronic device 302 can then use the retrieved information to perform a valuation of the property, such as by using MVA or MVI, as further described herein. After performing the valuation of the property, the electronic device 302 in some embodiments can generate an analysis summary and report, and is configured to store and/or transmit the report to other connected systems.

Although FIG. 3 illustrates one example of a valuation assessment platform 300, various changes may be made to FIG. 3. For example, valuation assessment platform 300 could include any number of each component in any suitable arrangement. In general, computing and communication systems come in a wide variety of configurations, and FIG. 3 does not limit the scope of this disclosure to any particular configuration. While FIG. 3 illustrates one operational environment in which various features disclosed in this patent document can be used, these features could be used in any other suitable system.

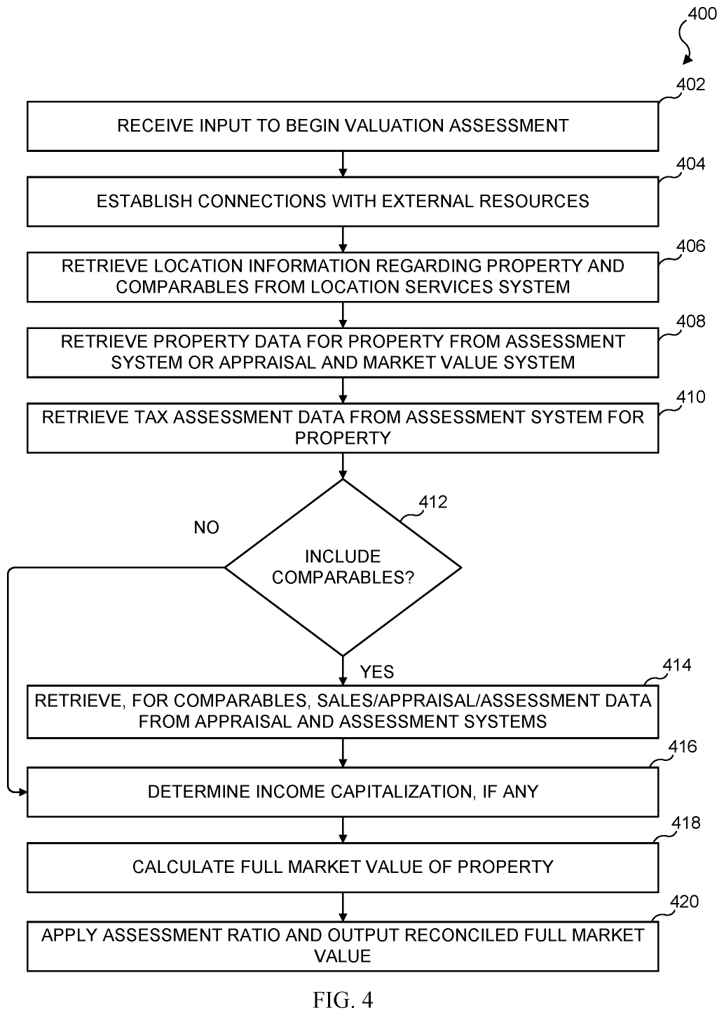

FIG. 4 illustrates a flowchart of a valuation platform analysis process 400 in accordance with this disclosure. FIG. 4 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. For ease of explanation, the process 400 is described with respect to the processor 120 of any, or a combination, of the electronic devices 101, 102, 104, or 302, or the server 106. However, the process 400 can be used with any other suitable device(s) and in any suitable system.

At block 402, the processor receives an input to begin a valuation assessment. In some embodiments, the input to begin a valuation assessment can be triggered by a user using the valuation software on the electronic device 302. At block 404, the processor establishes one or more connections with external resources, such as the location services system 306, the appraisal and market value system 308, and/or the assessment system 310, as described with respect to FIG. 3. At block 406, the processor retrieves location information regarding the subject property, if such is not already stored in the system and accessible to the processor. At block 408, the processor, using the location data retrieved from the location services system 306, or other data accessible by the processor such as known location data, owner data, property identification numbers, or other data, retrieves property data for the subject property from the appraisal and market value system 308 and/or the assessment system 310. The property data retrieved by the processor from the appraisal and market value system 308 and/or the assessment system 310 can be the data as described herein with respect to FIG. 3. At block 410, the processor retrieves tax assessment data from the assessment system for the subject property. In some embodiments, the appraisal and market value system 308 and the assessment system 310 can be the same system or components of a single system.

At decision block 412, the processor determines if sales comparables are to be included. In some embodiments of the process 400, the processor uses MVI to perform the valuation analysis. In some embodiments of the process 400, the processor uses MVA to perform valuation analysis. When using MVI, data regarding other properties is not used. When using MVA, comparables are used. If, at decision block 412, the processor determines that comparables are not to be included, the process 400 moves to block 416. If, at decision block 412, the processor determines that comparables are to be included, the process moves to block 414. At block 414, the processor retrieves, for the comparables, sales/appraisal data and assessment data from the appraisal and market value system and/or from the assessment system. The comparable properties used in the process 400 can be determined by using the location of the subject property retrieved from the location services system and retrieving data from the location services system on other properties that neighbor the subject property.

For example, the processor can increment or decrement the address number of the subject property to retrieve information for a property that is one address number over from the subject property. In this embodiment, the processor can increment or decrement the number multiple times to retrieve location information for a plurality of properties near the subject property. For a property that is a relatively larger distance from another property, the processor can use the location services system 306 to perform a search on the subject property, and then locate other properties that are closest to the subject property. Data retrieved by the processor can be reviewed by a user for accuracy, and comparable properties retrieved by the processor can be discarded, such as if the property is not close enough to the subject property, in a different county, or for other reasons. The process then moves to block 416. At block 416, the processor determines the income capitalization, if any, for the subject property, such as if the property is a commercial property. Block 416 may only be performed when specifically requested as part of the analysis.

At block 418, the processor calculates the full market value of the property. In some embodiments, the tax assessment value of the property can be used as the full market value. In some embodiments, the assessment value can be retrieved and recorded as a data point, but the processor further calculates the full market value from the appraised value, or calculates the full market value from the assessed value with respect to known information retrieved regarding the property, such as size, amenities, etc. The full market value, when using comparables, can also be determined and adjusted using the comparables. For example, if the processor determines the full market value of the subject property based on the appraised value, the processor can then use comparables data to adjust the full market value. For instance, the processor can determine an average price per square foot of the comparables and adjust the full market values for the subject property to be consistent with the average price per square foot, while still adjusting for amenities or other factors the subject property may have.

At block 420, in some embodiments the processor applies an assessment ratio to the full market value calculated at block 418, to output a final reconciled full market value for the subject property. The processor can obtain ratio study information for an area in which the property is located. Ratio studies are studies performed by appraisal districts, state comptrollers, or other local or state governments to evaluate appraisals and/or tax assessments for given areas, counties, properties in particular school districts, etc. In some embodiments, the processor can access websites with ratio study information and pull this information from the website to be used in the process 400. In some embodiments, the processor uses the obtained ratio studies to calculate a median ratio to full market value. For example, if the ratio study data includes multiple properties in a same neighborhood as the subject property, a median ratio for those properties can be calculated. In some embodiments, the processor calculates a mean ratio.

At block 420, the processor applies the ratio to the full market value of the property determined in block 418. For example, if the full market value is $500,000, and the median ratio difference is 8% (a 92% appraisal-to-sale-price ratio), the reconciled full market value can be calculated as $460,000. In some embodiments, depending on the data available to the processor, the ratio can be used to provide a higher reconciled value than the full market value, such as a value of $540,000. The processor can then compile all information retrieved in the process 400 for the subject property and comparable properties, and generate a report that can be stored, viewed, or transmitted, detailing the retrieved data and providing the reconciled full market value.

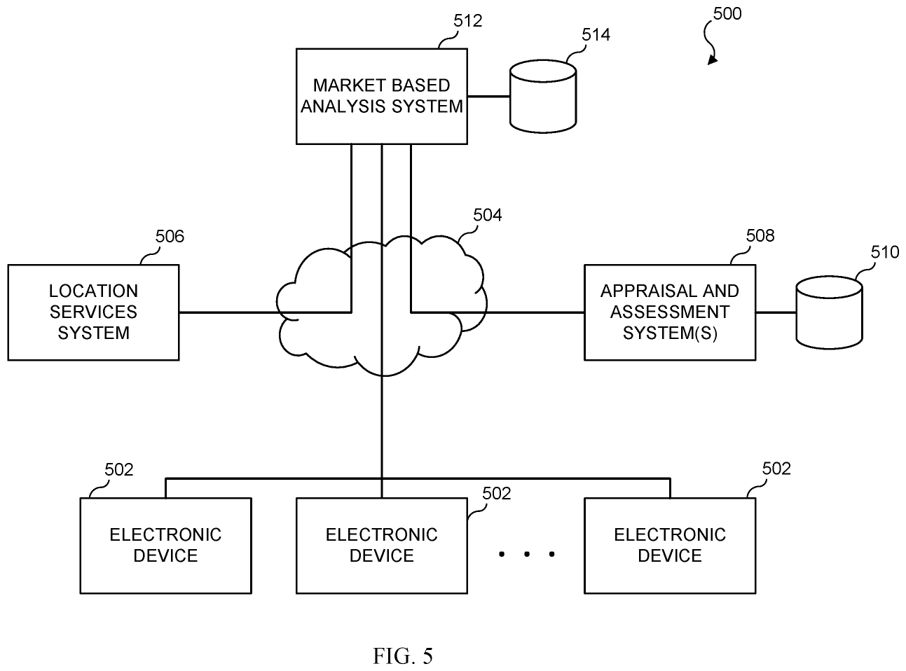

FIG. 5 illustrates an example interconnected valuation assessment platform 500 in accordance with this disclosure. It will be understood that the platform 500 can include the components illustrated in FIG. 1. The embodiment of the platform 500 shown in FIG. 5 is for illustration only. Other embodiments of the platform 500 could be used without departing from the scope of this disclosure.

The platform 500 includes a plurality of electronic devices 502. The electronic devices 502 can be a client device running valuation software. In some embodiments, the electronic devices 502 can be the electronic device 101, and the valuation software can be the program 140. In various embodiments of the present application, the electronic devices 502 can be communicatively connected with a market-based analysis system 512 over a network 504. The network 504 can be the network 162 in some embodiments. The market-based analysis system 512 can be a server such as the server 106. In some embodiments, the market-based analysis system 512 performs valuation functions, while the program 140 running on the electronic devices 502 provides a user interface to users of the electronic devices 502 for requesting and presenting valuation information.

For example, the electronic devices 502 can present a graphical user interface (GUI) that allows the user to input initial information on a property or properties and request a valuation analysis on the property. The electronic device 502 transmits this information, such as through the communication interface 170 over the network 504 to the market-based analysis system 512. The market-based analysis system 512 then performs a valuation analysis of the property or properties using the information transmitted from the electronic device 502 and other information available to the market-based analysis system 512. The market-based analysis system 512 in some embodiments can include a database 514 associated therewith that stores information on properties such as property features and amenities, market data such as particular market trends, comparables, or other information on a particular market, such as a market of a particular geographical area, previous valuations performed for properties, and other information. The market-based analysis system 512 can use the information in the database 514 to perform the valuation requested by the electronic device 502.

The market-based analysis system 512 is also interconnected with other entities, allowing the market-based analysis system 512 to retrieve additional information to be used in the valuation that may not be yet stored in the database 514, or to update data stored in the database 514 with new or current information. The other entities can be any number of outside sources for retrieving information to be used in an analysis performed by the market-based analysis system 512. For example, as shown in FIG. 5, the market-based analysis system 512 can be connected over the network 504 to a location services system 506, and appraisal and assessment systems 508 that can include a database 510. The appraisal and assessment systems 508 can be one system, or separate appraisal and assessment systems, such as those described with respect to FIG. 3. Whether the appraisal and assessment systems 508 are one or more systems can depend on the location of the subject property. For example, the county in which the subject property is located may have a central appraisal district that maintains and publishes information on appraisals, and the county may also have a tax assessment office that maintains and publishes separate information on assessments. In some cases, a county may have information for both appraisals and tax assessments published on the same system.

The systems and methods disclosed herein can use various valuation approaches. These approaches include MVI, and MAV or MVA approaches. MAV or MVA is an approach that determines at least an initial valuation from tax assessments provided for a residential or commercial property, and includes comparable sales of nearby and/or similar properties to further adjust the assessed price of the property. MVI is an approach that uses tax assessments divorced from comparable sales. As further described herein, each approach can further adjust the value of the property by an assessment ratio based on ratio studies performed for the geographic area, e.g., the county, in which the property is located. These inputs are used to provide a reconciled conclusion or valuation of the subject property that is adjusted by comparable sales and/or the assessment ratio to provide a more accurate market valuation than other approaches that rely solely on traditional assessment, valuation, or appraisal processes. Under each approach, other data and information can be provided, such as photos of the subject property, inspection information for the subject property, physical characteristics of the subject property, assessment data, comparable market data, or other data and information.

To gather information needed to perform a valuation such as MVA or MVI, the market-based analysis system 512 connects to the location services system 506 and the appraisal and assessment systems 508, to retrieve data therefrom without using manual inputs from a user of the electronic device 302 or the market-based analysis system 512. In some embodiments, information that is not directly retrievable from the systems 506 and 508 can be gathered over time and stored in a location accessible by the market-based analysis system 512, such as a local storage location at the market-based analysis system 512, or on the database 514. The market-based analysis system 512 communicates with the location services system 506 to retrieve location data for the subject property, and other properties near the subject property for use in retrieving comparable sales and assessments for the other properties.

For example, the location services system 506 can be a system that uses GPS compatible devices and/or software to determine the location of devices and other objects, such as GOOGLE MAPS. The market-based analysis system 512 can retrieve information from the location services system 506 by using an API associated with the location services system 506 to provide location data to the API and request data from the API. For example, when the market-based analysis system 512 retrieves property comparables data, the market-based analysis system 512 submits an API call to the location services system 506 providing the location of the subject property, such as an address, and retrieves information from the location services system 506 for properties near the subject property, such as neighboring properties, or a closest property if the subject property is in a rural area. In some embodiments, properties to be used for comparables can be retrieved manually for the subject property.

To retrieve information on the subject property, the market-based analysis system 512 can connect to the appraisal and assessment systems 508 to retrieve any stored data on appraisals or other valuations of the market value of the subject property. This data may be stored in the database 510 or other data storage location associated with the appraisal and assessment systems 508. For example, a Central Appraisal District for the county in which the subject property is located can store publicly accessible data for properties in the county, such as on a publicly accessible website, and this data can be accessed by inputting information identifying the property, such as an owner name or an address. The data stored in relation to a property on the appraisal and assessment systems 508 can include owner information, deed transfer date information, whether the property is residential or commercial, appraisal or full market value information (FMV) such as land valuation, improvements valuation, a total market value based on the sum of the land and improvements valuations, the year in which the appraisal or valuation was performed, and/or the year in which the next appraisal or valuation is scheduled to be performed, and location information such as an address, a subdivision or neighborhood, block and lot numbers, or other location information.

The data can also include information used in the appraisal of the FMV of the property, including an overall desirability rating, building class, construction type, i.e., frame, the year the property was built, the effective year built, the actual age of the property, total lot size, living area size (square footage), percent of building complete (can be less than 100% if building still being performed), number of stories, a depreciation percentage, foundation type (slab, pier and beam, etc.), roof type, i.e., gable, roof material, i.e., composite shingles, fence type, i.e., wood, metal, etc., exterior wall material, i.e., brick, stone, siding, etc., whether the property has a basement, heating and air condition types, i.e., central air, window units, etc., number of kitchens, bathrooms, and bedrooms, number of wet bars, number of fireplaces, and whether the property includes other amenities such as a sprinkler system, a deck, a spa, a pool, a sauna, or other amenities. The data can further include information on additional improvements, such as an attached garage, data on the type of property in the residential or commercial categories, such as a single family residence, data on taxing jurisdiction that identifies the city, school district, county, colleges, hospitals, and other entities that benefit from taxation of the property, data on any tax exemptions for the property, such a homestead exemption, agricultural exemption, or other exemptions, the taxable value of the property for each benefiting entity minus the exemptions, tax rates for each of the benefiting entities, and total annual taxes to be levied on the property.

To further retrieve information on the subject property, the market-based analysis system 512 can also connect to the appraisal and assessment systems 508 to retrieve stored data on tax assessments for the subject property. This data may be stored in the database 510 or other data store associated with the appraisal and assessment systems 508. For example, the county in which the subject property is located can store publicly accessible data for properties in the county, such as on a publicly accessible county tax office website, and this data can be accessed by inputting information identifying the property, such as an owner name or an address. The data stored in relation to a property on the appraisal and assessment systems 508 can include any of the information listed above regarding appraisals, and also the current tax levy on a property. Generally, information on assessments stored in the appraisal and assessment systems 508 will include the actual current tax levy for the property, whereas the information on appraisals often includes tax estimates based on the appraised value of the property. In some embodiments, the appraisal and assessment systems 508 can include tax assessment and appraisal values for the subject property that are the same, such as if the tax assessment uses a recent appraisal or sale price based on an appraisal or other similar valuation of the property as the tax assessment value. In some embodiments, the tax assessment and appraisal values can be different values, such as if the appraised value, or the full market value, is analyzed independently of the tax assessment value, and the assessment value can include a calculation of the actual value of the property rather than a market value.

The market-based analysis system 512 can access the publicly available information of the appraisal and assessment systems 508 to retrieve information on the subject property and any comparable properties based on location data for the property retrieved from the location services system 506. The market-based analysis system 512 can then use the retrieved information to perform a valuation of the property, such as by using MVA or MVI, as further described herein. After performing the valuation of the property, the market-based analysis system 512 in some embodiments can generate an analysis summary and report, and is configured to store and/or transmit the report to other connected systems, such as the electronic devices 502.

Although FIG. 5 illustrates one example of a valuation assessment platform 500, various changes may be made to FIG. 5. For example, valuation assessment platform 500 could include any number of each component in any suitable arrangement. In general, computing and communication systems come in a wide variety of configurations, and FIG. 5 does not limit the scope of this disclosure to any particular configuration. While FIG. 5 illustrates one operational environment in which various features disclosed in this patent document can be used, these features could be used in any other suitable system.

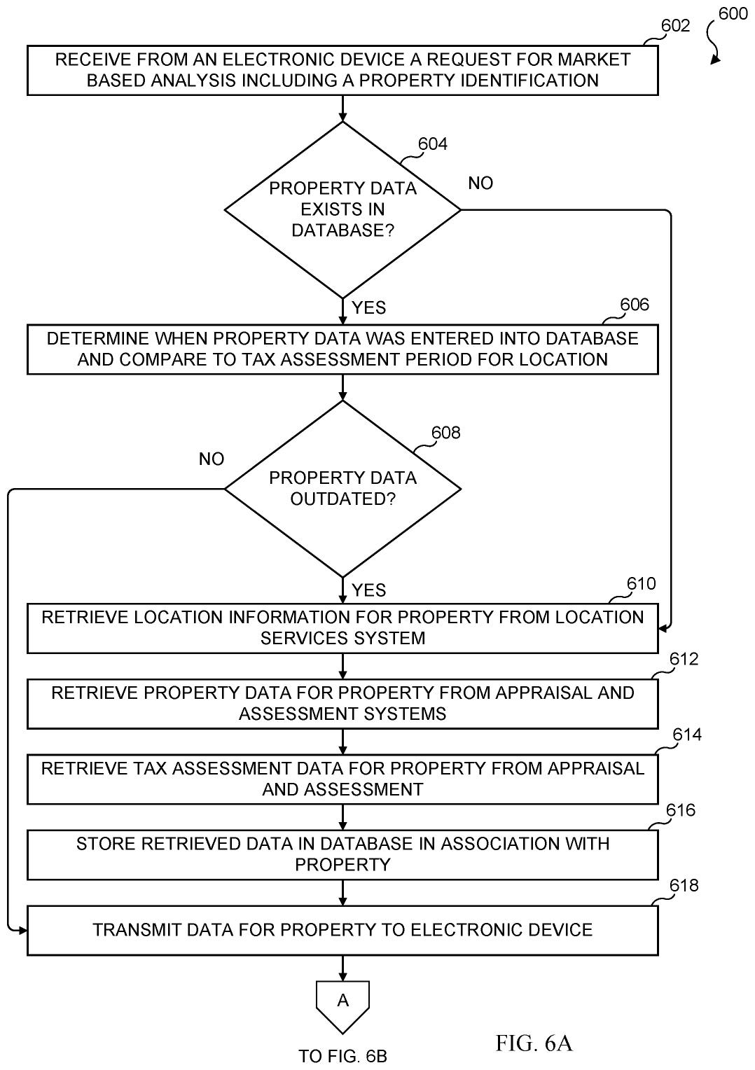

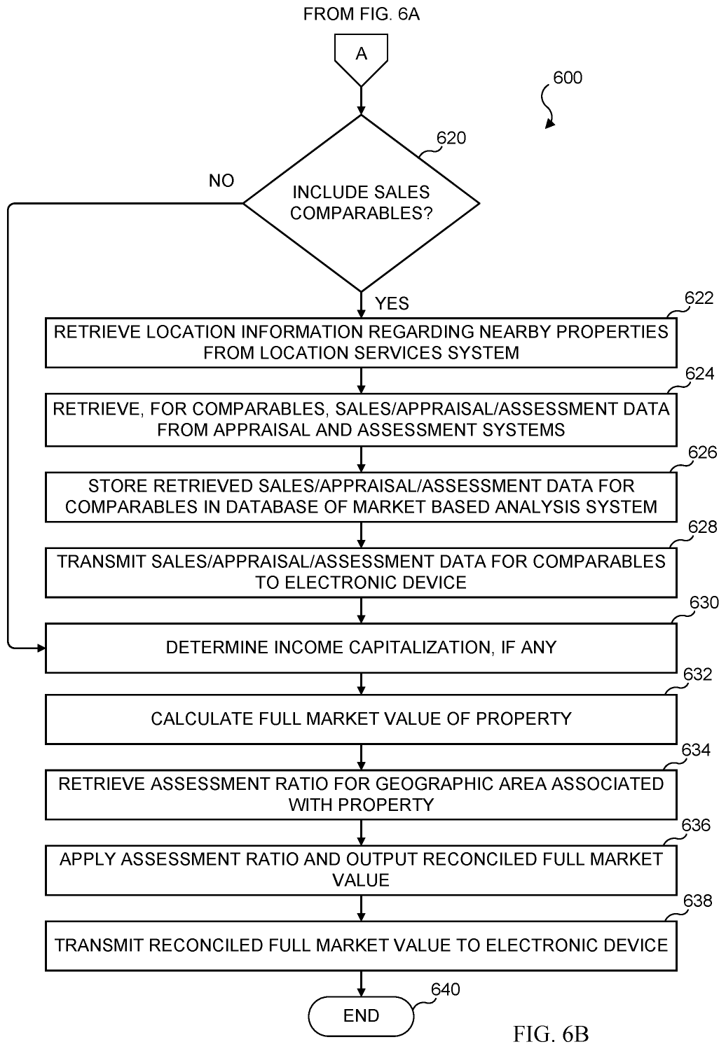

FIGS. 6A and 6B illustrate a flowchart of a valuation platform analysis process 600 in accordance with this disclosure. FIGS. 6A and 6B do not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. For ease of explanation, the process 600 is described with respect to the processor 120 of any, or a combination, of the electronic devices 101, 102, 104, or the server 106, or of the market-based analysis system 512. However, the process 600 can be used with any other suitable device(s) and in any suitable system.

At block 602, the processor receives a request from an electronic device, such as an electronic device 502, for a market-based analysis. In some embodiments, the request can include information such as a property identification for the property on which the analysis is to be performed. In some embodiments, the request is transmitted from the electronic device and can be triggered by a user using valuation software on the electronic device. At decision block 604, the processor determines if information on the property identified in the request received at block 602 is currently stored in a database or other type of data store accessible to the processor. If not, the process 600 moves to block 610. If so, the process 600 moves to block 606. The database or data store can, in some embodiments, be the database 514. At block 606, the processor determines when the data for the subject property was entered into the database or other data store, and can also compare this timing or date information to a known tax assessment period for the location of the subject property. For instance, if the subject property is in a county that performs new tax assessments every two years, for example, and the processor determines that the property data in the database is from four years prior to the date of the request received in block 602, the information for the property is likely outdated. The date or time information for when the data was entered into the database can be a timestamp in some embodiments. In some embodiments, the date or timestamp in the database can be the date of the tax assessment, rather than the date the property data was entered into the database.

The process 600 then moves to decision block 608. At decision block 608, the processor determines if the property data retrieved in block 606 is outdated. If not, the process 600 moves to block 618. If so, the process 600 moves to block 610. At block 610, the processor establishes one or more connections with external resources, such as the location services system 506 and/or the appraisal and assessment systems 508, as described with respect to FIG. 5, and the processor retrieves location information regarding the subject property, if such is not already stored in the system and accessible to the processor. At block 612, the processor, using the location data retrieved from the location services system, or other data accessible by the processor such as known location data, owner data, property identification numbers, or other data, retrieves property data for the subject property from appraisal and/or assessment systems, such as the appraisal and assessment systems 508. The property data retrieved by the processor from the appraisal and/or assessment systems can be the data as described herein with respect to FIG. 5. At block 614, the processor retrieves tax assessment data from the appraisal and/or assessment systems.

At block 616, the processor stores the retrieved data for the property in the database or other data store in association with a record for the subject property. The process moves to block 618, either from block 616 or from decision block 608 if property data in the database is determined to not be outdated. At block 618, the processor transmits the retrieved data for the property to the electronic device that requested the analysis in block 602. In some embodiments, block 618 is performed prior to the processor performing the valuation. For example, the processor can transmit the retrieved data for the subject property to the electronic device so that the electronic device can display the retrieved data to a user prior to performance of the valuation, but the transmission can be in a close time proximity to the valuation and transmission of valuation results, such that the user sees the property data populated in the GUI displayed on the electronic device, and shortly thereafter sees the display of valuation results. In some embodiments, the transmission at block 618 can be performed after the valuation.

The process 600 then moves to decision block 620. At decision block 620, the processor determines if sales comparables are to be included. In some embodiments of the process 600, the processor uses MVI to perform the valuation analysis. In some embodiments of the process 600, the processor uses MVA to perform valuation analysis. Which valuation approach to be used can depend on parameters chosen by the user of the electronic device and included in the request transmitted to the processor at block 602. For example, a user may choose to use either MVI or MVA based on the property type of the subject property, such as residential or commercial, based on personal preference of the user, or based on other criteria. When using MVI, data regarding other properties, or comparables, is not used. When using MVA, comparables are used. If, at decision block 620, the processor determines that comparables are not to be included, the process 600 moves to block 630. If, at decision block 620, the processor determines that comparables are to be included, the process moves to block 622. At block 622, the processor establishes one or more connections with the location services system and retrieves location information regarding nearby properties for the subject property. The comparable properties used in the process 600 can be determined by using the location of the subject property retrieved from the location services system and retrieving data from the location services system on other properties that neighbor the subject property.

For example, the processor can increment or decrement the address number of the subject property to retrieve information for a property that is one address number over from the subject property. In this embodiment, the processor can increment or decrement the number multiple times to retrieve location information for a plurality of properties near the subject property. For a property that is a relatively larger distance from another property, the processor can use the location services system to perform a search on the subject property, and then locate other properties that are closest to the subject property. Data retrieved by the processor can be reviewed by a user for accuracy, and comparable properties retrieved by the processor can be discarded, such as if the property is not close enough to the subject property, in a different county, or for other reasons. In some embodiments, comparable properties can be identified manually, such as by the user of the electronic device. The process then moves to block 624. At block 624, the processor retrieves, for the comparables, sales/appraisal data and assessment data from the assessment and appraisal systems. This information can include the property information as described with respect to FIG. 5, including tax assessment and appraisal values for the comparable properties. At block 626, the processor stores the retrieved stales/appraisal data and the assessment data in the database or data store of the market-based analysis system. At block 628, the processor transmits the sales/appraisal data and the assessment data for the comparables to the electronic device. In some embodiments, blocks 620-628 may be performed at or near the same time as blocks 610-618. For example, the processor can determine at decision block 608 whether to include data for comparables, and data for comparables can be retrieved in blocks 612-614.

The process 600 moves to block 630 either from block 628 or from decision block 620 if the processor determines that sales comparables are not to be included. At block 630, the processor determines the income capitalization, if any, for the subject property, such as if the property is a commercial property. In some embodiments, block 630 may only be performed when specifically requested as part of the analysis. At block 632, the processor calculates the full market value of the property. In some embodiments, the tax assessment value of the property can be used as the full market value. In some embodiments, the assessment value can be retrieved and recorded as a data point, but the processor further calculates the full market value from the appraised value, or calculates the full market value from the assessed value with respect to known information retrieved regarding the property, such as size, amenities, etc. The full market value, when using comparables, can also be determined and adjusted using the comparables. For example, if the processor determines the full market value of the subject property based on the appraised value, the processor can then use comparables data to adjust the full market value. For instance, the processor can determine an average price per square foot of the comparables and adjust the full market value for the subject property to be consistent with the average price per square foot, while still adjusting for amenities or other factors the subject property may have.

At block 634, in some embodiments the processor applies an assessment ratio to the full market value calculated at block 632, to output a final reconciled full market value for the subject property. In some embodiments, an assessment ratio can be applied to an assessed value of the subject property. The processor can obtain ratio study information for an area in which the property is located. In some embodiments, the processor can access websites with ratio study information and pull this information from the website to be used in the process 600. In some embodiments, the processor uses the obtained ratio studies to calculate a median ratio to full market value. For example, if the ratio study data includes multiple properties in a same neighborhood as the subject property, a median ratio for those properties can be calculated. In some embodiments, the processor calculates a mean ratio.

At block 636, the processor applies the ratio to the full market value of the property determined in block 632. For example, if the full market value is $500,000, and the median ratio difference is 8% (a 92% appraisal-to-sale-price ratio), the reconciled full market value can be calculated as $460,000. In some embodiments, depending on the data available to the processor, the ratio can be used to provide a higher reconciled value than the full market value, such as a value of $540,000. The processor can then compile all information retrieved in the process 600 for the subject property and comparable properties, and generate a report that can be stored, viewed, or transmitted, detailing the retrieved data and providing the reconciled full market value. At block 638, the processor transmits the reconciled full market value to the electronic device that requested the analysis at block 602, for display to the user on the electronic device. The processor can also transmit the report including all the compiled information on the subject property and any comparables to the electronic device, for display to the user on the electronic device. The process 600 ends at block 640.

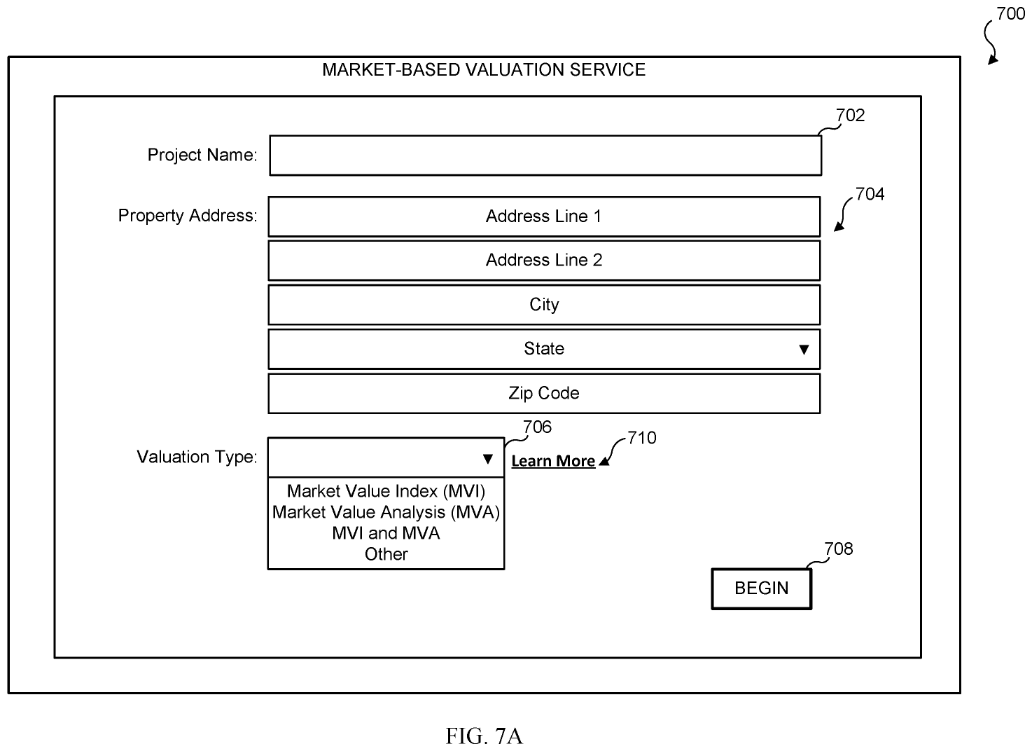

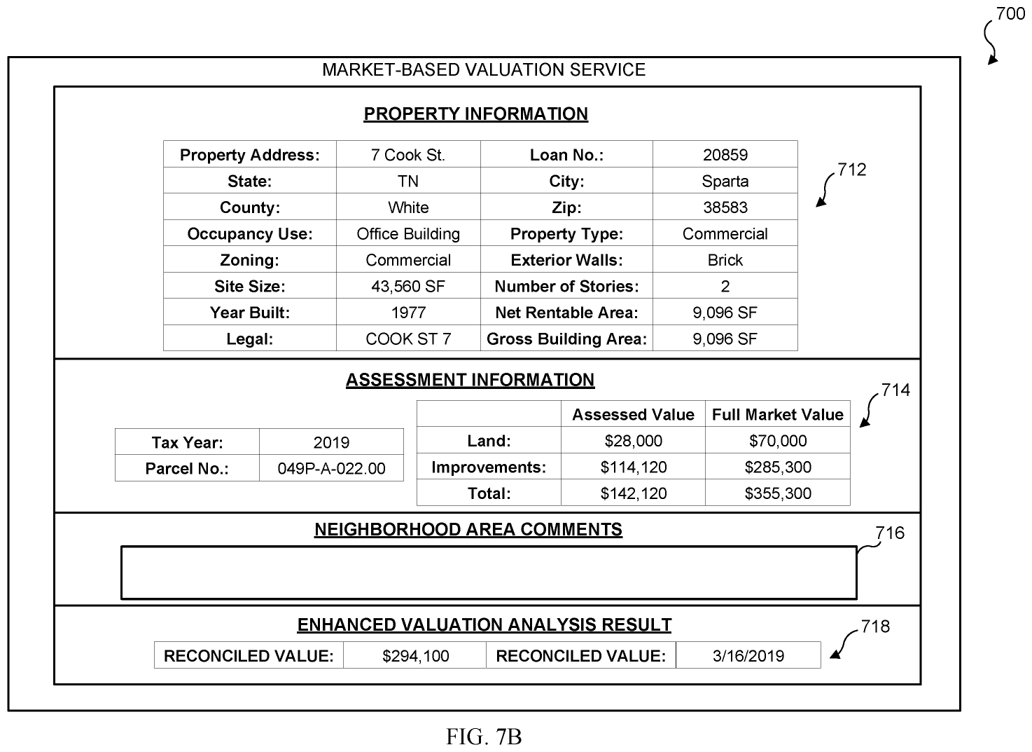

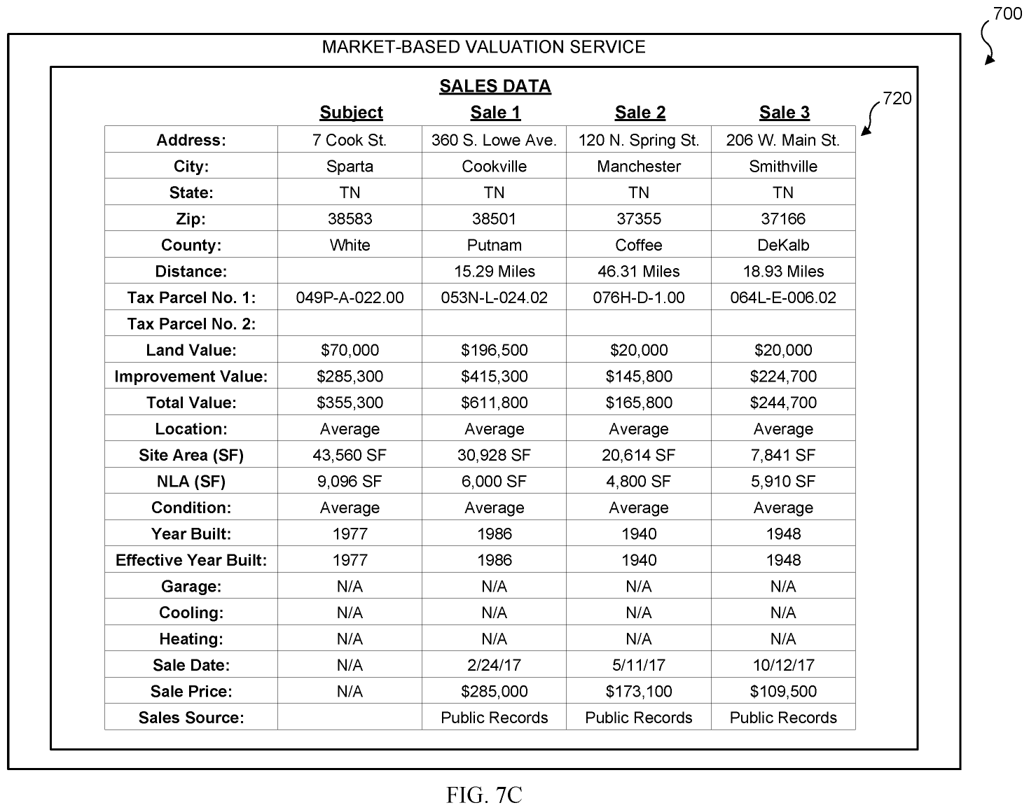

FIGS. 7A-7C illustrate various views of an example market-based valuation service GUI 700 in accordance with this disclosure. It will be understood that the example GUI 700 is merely one example of a GUI that can be used with the various embodiments of this disclosure; other formats for the GUI can be used without departing from this disclosure. The GUI 700 can be one example of a GUI of application software, such as program 140, running on an electronic device such as electronic devices 101, 102, 104, the server 106, the electronic device 302, electronic device 502, or the market-based analysis system 512.

As illustrated in FIG. 7A, the GUI 700 can include an interface for initiating or requesting a valuation of a property. This interface can include, but is not limited to, a project name text-fillable field 702, one or more property address text-fillable fields 704, a valuation type dropdown menu 706, and a begin button 708. The project name text-fillable field 702 allows for a user to enter a name for the valuation, to distinguish the particular valuation from other valuations the user may have requested. The one or more property address text-fillable fields 704 allow the user to enter an address for a property that is to be the subject of the valuation. The one or more property address text-fillable fields 704 can include multiple text-fillable fields for different portions of the property address, such as address lines 1 and 2, city, state, and zip code fields. In some embodiments, the state field can be a dropdown menu. As described in this disclosure, in some embodiments, the address provided in the one or more property address text-fillable fields 704 can be used as a property identifier sent in a request for a valuation, to allow the platform to locate and retrieve information on the subject property.

The valuation type dropdown menu 706 allows the user to select which type of valuation they wish to have performed, such as MVI, MVA, or both, or other valuation types as disclosed herein. In some embodiments, a “learn more” link 710 can be positioned near the valuation type dropdown menu 706 that triggers a display in the GUI 700, or in another GUI window, information on the different valuation types to assist the user in deciding which valuation type to use. Once the user provides information in each of the fields and selects the various options in the drop-down menus, the user can click, touch, or otherwise select the begin button 708 to initiate the valuation process or transmit a valuation request. It will be understood that the portion of the GUI 700 illustrated in FIG. 7A can include other user interface elements, such as fields for entering other property data such as a current owner name of the subject property, an ID, parcel number, or other property identifiers, or other property information, one or more fields to enter a company name for the company performing or requesting the valuation, or other data.

As shown in FIG. 7B and 7C, in response to a submitted request for a valuation, the GUI 700 can include various interface elements detailing the subject property and comparable properties, as well as valuation results. As shown in FIG. 7B, the GUI 700 can include one or more property information elements 712. The property information elements 712 can display information on the subject property retrieved from sources described in this disclosure, such as the location services system 306, the appraisal and market value system 308, the assessment system 310, the location services system 506, the appraisal and assessment systems 508, the database 514, and/or other sources. For example, the property information elements 712 can include information on the subject property such as the property address including street number and name, state, city, and zip code, the county in which the subject property is located, a loan number for a loan being processed for the subject property, exterior wall material type, site size, net rentable area size, gross building area, number of stories, the year the subject property was built, a legal listing of the subject property, a type of occupancy use for the subject property, such as office building, apartment complex, single-family home, etc., a property type, such as residential or commercial, and a zoning type, such as residential or commercial, or other information such as amenities included on the subject property. As shown in FIG. 7C, similar information can also be presented in sales data elements 720 of the GUI 700 concerning comparable properties.

The GUI 700 can also include assessment information elements 714. The assessment information elements 714 can include information describing a tax assessment, an appraisal/sale, or both, for the subject property, such as the tax year, parcel numbers, assessed and full market values for the land of the subject property and the improvements of the subject property, and the total assessed and full market values for the property. As shown in FIG. 7C, similar assessment data can be provided for the comparable properties in the sales data elements 720, and presented next to the information for the subject property for comparison. The assessed value can be the assessed value from a previous tax assessment performed on the property while the full market value can be the most recent appraised or sale price of the property. In some embodiments, the assessed value or the full market value listed in the assessment information elements 714 of the GUI 700 can be refined by the comparables for the subject property. For example, the assessed value can be taken from the mean, median, or another calculation of the previous tax assessment for the subject property with the comparables.

For example, the tax assessment for the subject property can be averaged with the tax assessments for the comparable properties. Likewise, the full market value can be taken from the mean, median, or another calculation of the previous appraisal or sale of the subject property and of the comparables. For instance, the appraisal or sale of the subject property can be averaged with appraisal or sale for the comparable properties. It will be understood that in adjusting the assessed and full market values for the subject property, comparables that are deemed as outliers due to drastically different pricing values, distance, or other outlier criteria, can be discarded so as not to greatly skew the assessed or full market value for the subject property. The GUI 700 can also include additional information interface elements 716. The additional information interface elements 716 can include elements such as a text field to display miscellaneous comments concerning the subject property or comparables, or other information such as photos of the subject property, inspection information for the subject property, other physical characteristics of the subject property, the particular condition of certain property features, or other data and information.

The GUI 700 can further include reconciled assessment or full market value results elements 718. Elements 718 can include a final reconciled value and a reconciled value date, or other information. As described in this disclosure, valuation processes of this disclosure can apply a ratio to the assessment value or the full market value of the subject property. For example, as shown in FIG. 7B, if the total full market value is $355,300, and the median ratio difference is about 17%, the reconciled full market value can be calculated as $294,100. In some embodiments, depending on the data available to the processor, such as if the property data for the subject property and the comparables indicates the subject property should be valued higher, the ratio can be used to provide a higher reconciled value than the full market value, such as a value of $416,500 (+≈17% of the full market value). It will be understood that this is but one example, and different ratio values can be used depending on the data retrieved from the ratio studies. It will be understood that an assessment ratio could be applied to the assessed value to provide a reconciled assessed value.

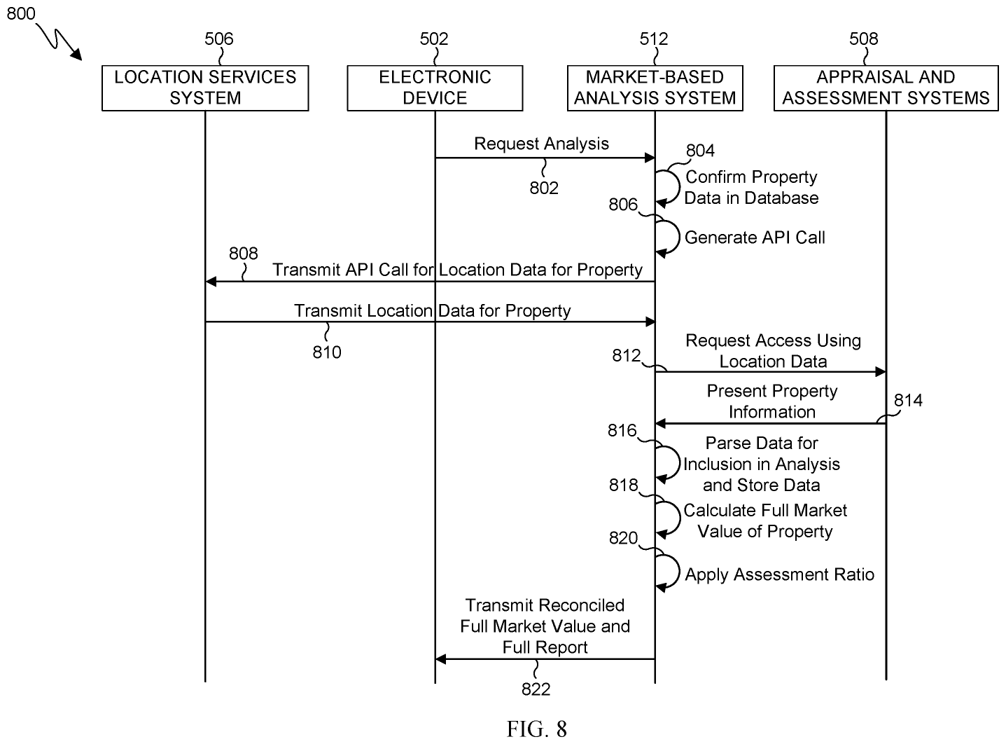

FIG. 8 illustrates a sequence diagram of an example market-based analysis process 800 in accordance with this disclosure. It will be understood that the process 800 is described with respect to the processor 120 of any, or a combination, of the electronic devices 101, 102, or 104, or the server 106, and/or the electronic devices 502, the locations services system 506, the appraisal and assessment systems 508, and the market-based analysis system 512. However, the process 800 can be used with any other suitable device(s) and in any suitable system.

As illustrated in FIG. 8, various steps of the process 800 are performed by electronic device 502, location services system 506, appraisal and assessment systems 508, and market-based analysis system 512. At step 802, the electronic device 502 transmits a request for a market-based analysis to the market-based analysis system 512. In some embodiments, the request can include information such as a property identification for the property on which the analysis is to be performed. In some embodiments, the request can be triggered by a user using valuation software on the electronic device. At step 804, the market-based analysis system 512 confirms if information on the property identified in the request received in step 802 is currently stored in a database or other type of data store accessible to the market-based analysis system 512. As described herein, the market-based analysis system 512 can use data already stored in the database 514 in the analysis, or can determine to update the database 514 if information on the property is outdated or does not currently exist in the database 514.

At step 806, the market-based analysis system 512 generates an API call for transmission to the location services system 506. The API call can include property identification data, such as an address, for the subject property and/or comparables. At step 808, the market-based analysis system 512 transmits the API call to the location services system 506. At step 810, the location services system 506 transmits location data for the property that was identified in the API call to the market-based analysis system 512. At step 812, the market-based analysis system 512, using the location data retrieved from the location services system, and/or other data accessible to the market-based analysis system 512, such as known location data, owner data, property identification numbers, or other data, requests access to the appraisal and assessment systems 508 to retrieve property data for the subject property and/or comparables from the assessment and appraisal and assessment systems 508. At step 814, the appraisal and assessment systems 508 presents property information to the market-based analysis system 512. The property data retrieved by the market-based analysis system 512 from the appraisal and assessment systems 508 can be the data as described herein with respect to FIG. 5. At step 816, the market-based analysis system 512 parses the presented data for data to be used in the analysis, such as tax assessment data, assessment ratio data (unless already known by the market-based analysis system 512), full market value, sales, and/or appraisal data, property features data, or other data. The market-based analysis system 512 can then store the data on the database 514.

At step 818, the market-based analysis system 512 calculates the full market value of the property. In some embodiments, the tax assessment value of the property can be used as the full market value. In some embodiments, the assessment value can be retrieved and recorded as a data point, but the market-based analysis system 512 further calculates the full market value from the appraised value, or calculates the full market value from the assessed value with respect to known information retrieved regarding the property, such as size, amenities, etc. The full market value, when using comparables, can also be determined and adjusted using the comparables. For example, if the market-based analysis system 512 determines the full market value of the subject property based on the appraised value, the market-based analysis system 512 can then use comparables data to adjust the full market value. For instance, the market-based analysis system 512 can determine an average price per square foot of the comparables and adjust the full market values for the subject property to be consistent with the average price per square foot, while still adjusting for amenities or other factors the subject property may have.

At step 820, the market-based analysis system 512 applies an assessment ratio to the full market value calculated at step 818, to output a final reconciled full market value for the subject property. The market-based analysis system 512 can use ratio study information for an area in which the property is located. In some embodiments, if the appraisal and assessment systems 508 do not include ratio studies information, the market-based analysis system 512 can access websites with ratio study information and pull this information from the website to be used in the process 800. In some embodiments, the market-based analysis system 512 uses the obtained ratio studies to calculate a median ratio to full market value. For example, if the ratio study data includes multiple properties in a same neighborhood as the subject property, a median ratio for those properties can be calculated. In some embodiments, the market-based analysis system 512 calculates a mean ratio. At step 822, the market-based analysis system 512 transmits the reconciled full market value to the electronic device 502, as well as a full report listing details for the subject property and any comparables, for display on the electronic device 502.

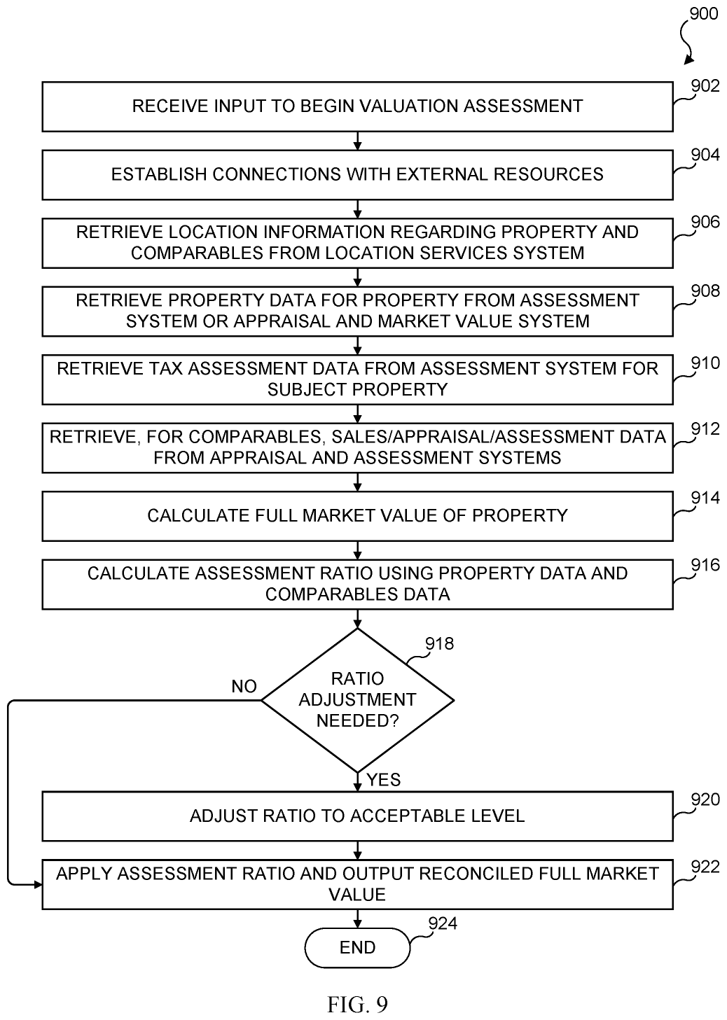

FIG. 9 illustrates a flowchart of an analysis process 900 in accordance with this disclosure. FIG. 9 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. For ease of explanation, the process 900 is described with respect to the processor 120 of any, or a combination, of the electronic devices 101, 102, 104, or 302, or the server 106. However, the process 900 can be used with any other suitable device(s) and in any suitable system.

At block 902, the processor receives an input to begin a valuation assessment. In some embodiments, the input to begin a valuation assessment can be triggered by a user using the valuation software on the electronic device 302. At block 904, the processor establishes one or more connections with external resources, such as the location services system 306, the appraisal and market value system 308, and/or the assessment system 310, as described with respect to FIG. 3. At block 906, the processor retrieves location information regarding the subject property, if such is not already stored in the system and accessible to the processor. At block 908, the processor, using the location data retrieved from the location services system 306, or other data accessible by the processor such as known location data, owner data, property identification numbers, or other data, retrieves property data for the subject property from the appraisal and market value system 308 and/or the assessment system 310. The property data retrieved by the processor from the appraisal and market value system 308 and/or the assessment system 310 can be the data as described herein with respect to FIG. 3. At block 910, the processor retrieves tax assessment data from the assessment system for the subject property. In some embodiments, the appraisal and market value system 308 and the assessment system 310 can be the same system or components of a single system.

At block 912, the processor retrieves, for the comparables, sales/appraisal data and assessment data from the appraisal and market value system and/or from the assessment system. The comparable properties used in the process 900 can be determined by using the location of the subject property retrieved from the location services system and retrieving data from the location services system on other properties that neighbor the subject property. For example, the processor can increment or decrement the address number of the subject property to retrieve information for a property that is one address number over from the subject property. In this embodiment, the processor can increment or decrement the number multiple times to retrieve location information for a plurality of properties near the subject property. For a property that is a relatively larger distance from another property, the processor can use the location services system 306 to perform a search on the subject property, and then locate other properties that are closest to the subject property. Data retrieved by the processor can be reviewed by a user for accuracy, and comparable properties retrieved by the processor can be discarded, such as if the property is not close enough to the subject property, in a different county, or for other reasons.

In some embodiments, the processor can also determine the income capitalization, if any, for the subject property, such as if the property is a commercial property. At block 914, the processor calculates the full market value of the property. In some embodiments, the tax assessment value of the property can be used as the full market value. In some embodiments, the assessment value can be retrieved and recorded as a data point, but the processor further calculates the full market value from the appraised value, or calculates the full market value from the assessed value with respect to known information retrieved regarding the property, such as size, amenities, etc. The full market value, when using comparables, can also be determined and adjusted using the comparables. For example, if the processor determines the full market value of the subject property based on the appraised value, the processor can then use comparables data to adjust the full market value. For instance, the processor can determine an average price per square foot of the comparables and adjust the full market values for the subject property to be consistent with the average price per square foot, while still adjusting for amenities or other factors the subject property may have.

At block 916, the processor calculates an assessment ratio using the retrieved property data and the retrieved comparables data. Although the assessment ratio can be retrieved from third-party sources, in some embodiments, the assessment ratio can be calculated by the processor. The processor can use sales figures on comparables to determine a median or mean plus/minus ratio between the comparables. In some embodiments, comparables that can be tagged as an outlier, i.e., the sales price is lower or higher than a threshold margin, can be included, while in some embodiments the outliers can be excluded. At decision block 918, the processor determines whether the calculated ratio needs to be adjusted, such as if the calculated ratio is too high or low than what is normal. For example, if fifty comparable properties are analyzed, with outliers either included or excluded, and the processor determines from the property data that the properties are within plus/minus 8% of each other, the processor can determine at decision block 918 that no adjustment is needed. The process 900 then moves to block 922.

However, if the calculated ratio is 45%, the processor can determine at decision block 918 that the ratio should be adjusted, and the process 900 then moves to block 920. At block 920, the processor adjusts the ratio to an acceptable level, such as 20%. It will be understood that the above ratios are merely examples, and the processor can be set to perform ratio adjustments at other levels. In some embodiments, the ratio can be adjusted to a particular ratio that is determined to be the highest or lowest possible ratio. In some embodiments, if the ratio calculation used outlier comparables, the processor can, after determining the ratio needs to be adjusted at decision block 918, discard the outlier comparables and re-calculate the assessment ratio using the non-outlier comparables. The process 900 moves from block 920 to block 922.

At block 922, the processor applies the determined assessment ratio to the full market value calculated at block 914, to output a final reconciled full market value for the subject property. In some embodiments, the processor calculates a median ratio to full market value. For example, if the multiple ratios are calculated for multiple properties in a same neighborhood as the subject property, a median ratio for those properties can be calculated. In some embodiments, the processor calculates a mean ratio. The processor applies the ratio to the full market value of the property determined in block 914. For example, if the full market value is $500,000, and the median ratio difference is 8% (a 92% appraisal-to-sale-price ratio), the reconciled full market value can be calculated as $460,000. In some embodiments, depending on the data available to the processor, the ratio can be used to provide a higher reconciled value than the full market value, such as a value of $540,000. The processor can then compile all information retrieved and calculated in the process 900 for the subject property and comparable properties, and generate a report that can be stored, viewed, or transmitted, detailing the retrieved data and providing the reconciled full market value. The process 900 ends at block 924.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An electronic device, comprising:
a memory; and
at least one processor coupled to the memory,
wherein the at least one processor is configured to:
receive a request for an assessment operation, wherein the request includes a property identification for a property;
calculate a full market value of the property;
obtain assessment ratio study information for a property area, wherein the property area is a geographical area related to the property;
determine an assessment ratio for the property area based on the obtained assessment ratio study information;
apply the assessment ratio to the full market value of the property; and
transmit a reconciled full market value in response to the request.

2. The electronic device of claim 1, wherein the assessment ratio is a median assessment ratio for the property area.

3. The electronic device of claim 1, wherein the at least one processor is further configured to:
determine that property data associated with the property is stored in a database connected to the electronic device; and
determine that the property data is outdated.

4. The electronic device of claim 3, wherein the at least one processor is further configured to:
generate an application programming interface (API) call including the property identification;
transmit the API call to a location services system; and
receive location data associated with the property from the location services system.

5. The electronic device of claim 4, wherein the at least one processor is further configured to:
retrieve updated property data associated with the property from a tax assessment system or from an appraisal system; and
store the updated property data in the database in association with the property.

6. The electronic device of claim 5, wherein, to calculate the full market value, the at least one processor is further configured to calculate the full market value based on the updated property data.

7. The electronic device of claim 6, wherein the updated property data includes tax assessment data for the property.

8. The electronic device of claim 5, wherein the at least one processor is further configured to:
retrieve information on at least one comparable property from the tax assessment system or from the appraisal system; and
calculate the full market value for the property based on the information on the at least one comparable property.

9. The electronic device of claim 8, wherein the at least one processor is further configured to:
create an identification for the at least one comparable property by incrementing or decrementing a value of the property identification for the property;
generate another API call including the identification for the at least one comparable property;
transmit the other API call to the location services system;
receive location data associated with the at least one comparable property from the location services system; and
retrieve the information on the at least one comparable property from tax assessment system or from the appraisal system using the location data associated with the at least one comparable property.

10. The electronic device of claim 8, wherein, to calculate the full market value for the property based on the information on the at least one comparable property, the at least one processor is further configured to:
discard any comparable property outliers of the at least one comparable property based on at least sales price; and
calculate a mean value of the at least one comparable.

11. A method of an electronic device, comprising:
receiving a request for an assessment operation, wherein the request includes a property identification for a property;
calculating a full market value of the property;
obtaining assessment ratio study information for a property area, wherein the property area is a geographical area related to the property;
determining an assessment ratio for the property area based on the obtained assessment ratio study information;
applying the assessment ratio to the full market value of the property; and
transmitting a reconciled full market value in response to the request.

12. The method of claim 11, wherein the assessment ratio is a median assessment ratio for the property area.

13. The method of claim 11, further comprising:
determining that property data associated with the property is stored in a database connected to the electronic device; and
determining that the property data is outdated.

14. The method of claim 13, further comprising:
generating an application programming interface (API) call including the property identification;
transmitting the API call to a location services system; and
receiving location data associated with the property from the location services system.

15. The method of claim 14, further comprising:
retrieving updated property data associated with the property from a tax assessment system or from an appraisal system; and
storing the updated property data in the database in association with the property.

16. The method of claim 15, wherein calculating the full market value includes calculating the full market value based on the updated property data.

17. The method of claim 16, wherein the updated property data includes tax assessment data for the property.

18. The method of claim 15, further comprising:
retrieving information on at least one comparable property from the tax assessment system or from the appraisal system; and
calculating the full market value for the property based on the information on the at least one comparable property.

19. The method of claim 18, further comprising:
creating an identification for the at least one comparable property by incrementing or decrementing a value of the property identification for the property;
generating another API call including the identification for the at least one comparable property;
transmitting the other API call to the location services system;
receiving location data associated with the at least one comparable property from the location services system; and
retrieving the information on the at least one comparable property from tax assessment system or from the appraisal system using the location data associated with the at least one comparable property.

20. The method of claim 18, wherein calculating the full market value for the property based on the information on the at least one comparable property includes:
discarding any comparable property outliers of the at least one comparable property based on at least sales price; and
calculating a mean value of the at least one comparable.
